(19) United States
(12) Patent Application Publication
(10) Pub. No.: US 2003/0043423 A1
(43) Pub. Date: Mar. 6, 2003

(54) System and method for scanning to a host computer

(76) Inventors: Kairi Ann Johnston, Star, ID (US); Honee Lee Mesa, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/943,622

(22) Filed: Aug. 30, 2001

(51) Int. Cl. H04N 1/46

(52) U.S. Cl. 358/505

(57) ABSTRACT

A scanning device for scanning to a host computer includes memory for storing a list of host IDs and corresponding host addresses, an image sensing module for scanning an image or document, and a display panel for displaying at least one host ID that is selectable via user input. The scanning device receives registration data from a host computer, displays a list of one or more registered host computers, receives user input identifying a host computer, scans a document or image to generate scan data, and transmits the scan data to the host computer identified by the user input.

### FIELD OF THE INVENTION

The present invention relates to image scanning devices and in particular relates to systems and methods for scanning to a host computer.

### BACKGROUND OF THE INVENTION

Image scanning devices are computer peripheral devices which optically scan an image source (i.e., a photographic image or printed text document) to produce a digital representation of that image. There are a number of different types of scanners including, for example, flat-bed scanners, sheet-fed scanners, photographic image scanners, etc. All such devices share a common architecture in that the colors and shapes of the source image are converted to a digital representation. In a digital representation, the continuous image source is transformed into a two-dimensional array of picture elements (commonly referred to as “pixels” or more simply as “dots”). Each pixel includes digital (i.e., numeric) information describing the colors and intensity of that pixel. The digital information in the array of pixels visually appears to recreate the original image source. The image is therefore said to be digitized.

Since scanning devices can be expensive and can take up valuable desk space, there is a big demand for shared scanning devices. However, shared scanning devices currently on the market are not easy and convenient to use. For example, some shared scanning devices require that the scan data be transmitted to a server; a user must then retrieve the scan data from the server after scanning a document or image at the scanning device. This requires host software to be loaded onto a server that every user has access to. Other shared scanning devices require a user to enter a receiving host's numerical identification number (ID) at the scanning device and require that the receiving host support JetSend technology in order for scan data to be transmitted to the receiving host. This is inconvenient since it may be difficult for a user to commit the receiving host's ID to memory or to remember to bring a written host ID to the scanning device. Therefore, there exists a need for a scanning device that is capable of being shared by a plurality of users and that is relatively easy and convenient to use.

### SUMMARY OF THE INVENTION

In one embodiment of the present invention, a method for scanning to a host computer includes receiving registration data from a host computer, displaying a list of one or more registered host computers, receiving user input identifying a host computer, scanning a document or image to generate scan data, and transmitting the scan data to the host computer identified by the user input.

In another embodiment, a method for scanning includes transmitting a registration request to the scanning device, receiving a scanning request from the scanning device, transmitting a scanning instruction to the scanning device in response to receiving the scanning request, receiving scan data from the scanning device, and transmitting a request to the scanning device requesting a cancellation of registration.

In yet another embodiment of the present invention, a scanning device for scanning to a host computer includes memory for storing a list of host IDs and corresponding host addresses, an image sensing module for scanning an image or document, and a display panel for displaying at least one host ID that is selectable via user input.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A depicts a non-limiting example of a scanning system that features a scanning device and a host computer that are coupled via a direct connection.

FIG. 1B depicts a non-limiting example of a scanning system that features a scanning device and a host computer that are coupled via a network.

FIG. 1C depicts a non-limiting example of a scanning system that is a hybrid of the scanning systems depicted in FIGS. 1A and 1B.

FIG. 2A is a block diagram depicting a non-limiting example of a scanning device in accordance with one embodiment of the present invention.

FIG. 2B depicts a non-limiting example of a scanning device that is an alternative embodiment of the scanning device depicted in FIG. 2A.

FIG. 3A depicts a non-limiting example of selected components of a control panel that can be used to receive user input designating a destination for scan data.

FIG. 3B depicts a non-limiting example of a control panel that is an alternative embodiment of the control panel depicted in FIG. 3A.

FIG. 3C depicts a non-limiting example of a control panel that is an alternative embodiment of the control panels depicted in FIGS. 3A and 3B.

FIG. 3D depicts a non-limiting example of a number pad that can be integrated into a control panel and that can be used to provide user input.

FIG. 4 is a block diagram depicting a non-limiting example of a host that can be used to communicate with a scanning device.

FIG. 5 depicts a non-limiting example of a host registration routine that is implemented by a scanning device that includes a display panel.

FIG. 6 depicts a non-limiting example of a host registration routine that is implemented by a scanning device that does not include a display panel.

FIG. 7 is a flow chart depicting an embodiment of a scanning process for a scanning device that has a display panel.

FIG. 8 is a flow chart depicting a non-limiting example of a scanning process for a scanning device that allows only one host to be registered, at any given time, to receive a scan.

### DETAILED DESCRIPTION

I. System Overview

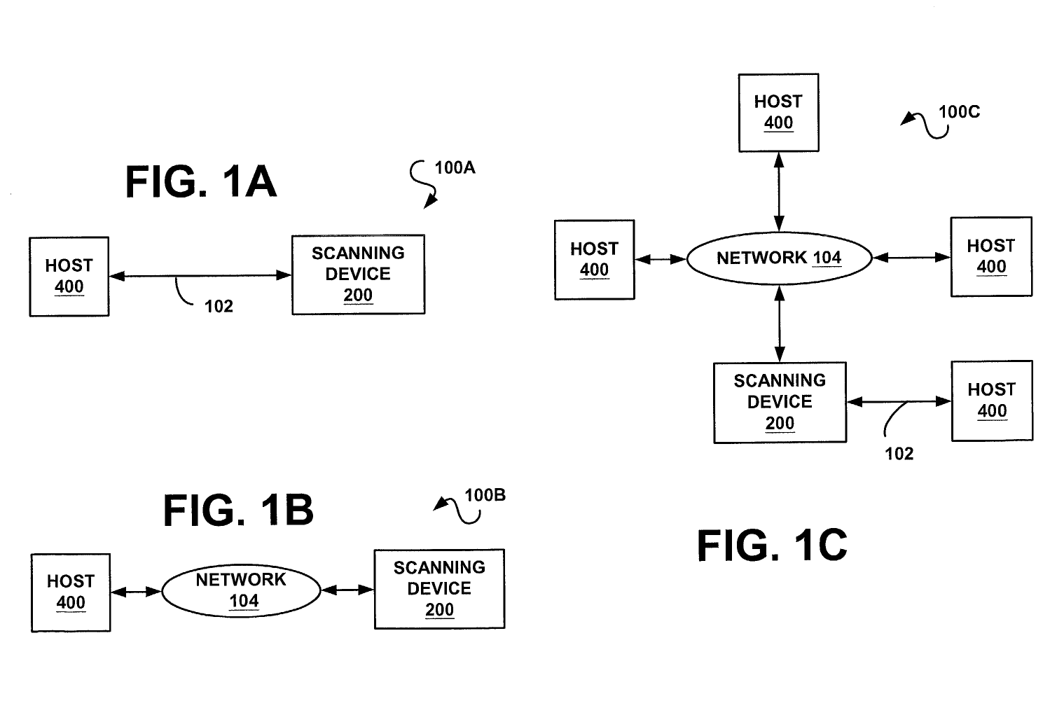

FIG. 1A depicts a non-limiting example of a scanning system 100A that includes a scanning device 200 and a host computer (“host”) 400 that are coupled via a direct connection 102. The direct connection 102 may be a wired or a wireless connection; a wired connection may comprise, for example, a twisted pair, a coaxial cable, an optical fiber, etc.; a wireless connection may comprise, for example, infra-red (IR) communication signals or radio frequency (RF) communication signals. The host 400 is a special or general purpose digital computer, such as a personal computer (PC; IBM-compatible, Apple-compatible, or otherwise), a workstation, a minicomputer, or a mainframe computer. The scanning device 200 may be, for example, a flat-bed scanner, a sheet-fed scanner, a drum scanner, a slide scanner, a photo scanner, or a multifunction device (MFD), etc. An MFD provides other functionality in addition to scanning, such as, for example, printing, faxing, and/or copying.

As shown in FIG. 1B, scanning system 100B includes a scanning device 200 that is coupled to a plurality of hosts 400 via a network 104 (only one host is shown). The network 104 may be any suitable network for connecting the scanning device 200 to the host 400 such as, for example, a Local Area Network (LAN), a Wide Area Network (WAN), or the Internet. The LAN may use one of several LAN technologies such as, for example, Ethernet, Tokenring, Asynchronous Transfer Mode (ATM), Fiber Distributed Data Interface (FDDI), Copper Distributed Data Interface (CDDI), or JetSend.

FIG. 1C depicts a non-limiting example of a scanning system 100C that is a hybrid of scanning systems 100A and 100B. Scanning system 100C includes a scanning device 200 that is coupled to a plurality of hosts 400 via a network 104 and to at least one host 400 via a direct connection 102.

An embodiment of the present invention allows a user to easily complete a scan via a scanning device 200 (FIGS. 1A, 1B, & 1C). This is achieved by allowing hosts to dynamically register and cancel registration with the scanning device 200. A host 400 (FIGS. 1A, 1B, & 1C) registers with a scanning device 200 by transmitting a registration request. The registration request may include a host identifier (ID) and a host technical identifier (TID). The TID includes whatever information the scanning device 200 needs to communicate with the host 400 such as, for example, an internet protocol (IP) address or a communication channel identifier. Host IDs may be displayed to a user via a display panel to allow easy recognition of the corresponding host. TIDs, however, are preferably not displayed to users since they are not easily recognized.

A list of hosts that are registered with a scanning device 200 is dynamic; hosts register and cancel registration as necessary. The scanning device 200 stores data that identifies all the hosts that are currently authorized to receive scanning notices from the scanning device 200. In this manner the list of registered hosts does not become outdated and does not require maintenance by an Information Systems (IS) specialist. In one implementation, the scanning device 200 periodically polls registered hosts to determined if it can still communicate with all the registered hosts; if any of the registered hosts does not respond, then the scanning device 200 removes such host from the list of registered hosts. In another possible implementation, after a host 400 registers with a scanning device 200, the host 400 will periodically poll the scanning device 200. If the host 400 does not receive a polling response from the scanning device 200, then the host 400 will attempt to re-establish communication with the scanning device 200. Once communication is re-established, the host 400 will attempt to re-register with the scanning device 200.

In one possible implementation, a user is provided with the option of designating a particular host 400 as the Main Host. A user may be unable to designate a particular host 400 as the Main Host if one or more other hosts are currently registered with the scanning device 200 for a scan. Once a host 400 is designated as the Main Host, then a scan to the Main Host can be achieved with one push of the Scan Button 316, and users will not be able to initiate a scan from scanning device 200 in connection with any other host; other hosts may only receive scan data in response to a scan that is initiated at a respective host.

In another possible implementation, once a scanning device 200 receives a request from a host 400 to start scanning a document or image, the scanning device 200 is locked into, or reserved for, the current scanning assignment. The scanning device 200 is not locked merely when the scan button is pressed; this is because the user may not necessarily wish to complete a scan at that time. When the scanning device 200 is locked into a scanning assignment, no other user can use the scanning device 200.

A locked scanning device may indicate that it is locked by displaying a message via a display panel. The display panel may state, for example, “Busy scanning to . . . ” or “waiting to scan to . . . ” If the locked scanning device is an MFD capable of performing facsimile or copying functionality, then such functionality may also not be used while the scanning device 200 remains locked. There may be a timeout associated with a locked scanning device. Characteristics of a timeout may be modifiable by a user. The scanning device 200 may become unlocked if there is a timeout or if the current scanning assignment is completed or cancelled. If a user attempts to initiate a scan directed to a locked scanning device from a host 400, the user will be presented with a message informing the user that the scanning device 200 is busy.

II. System Components

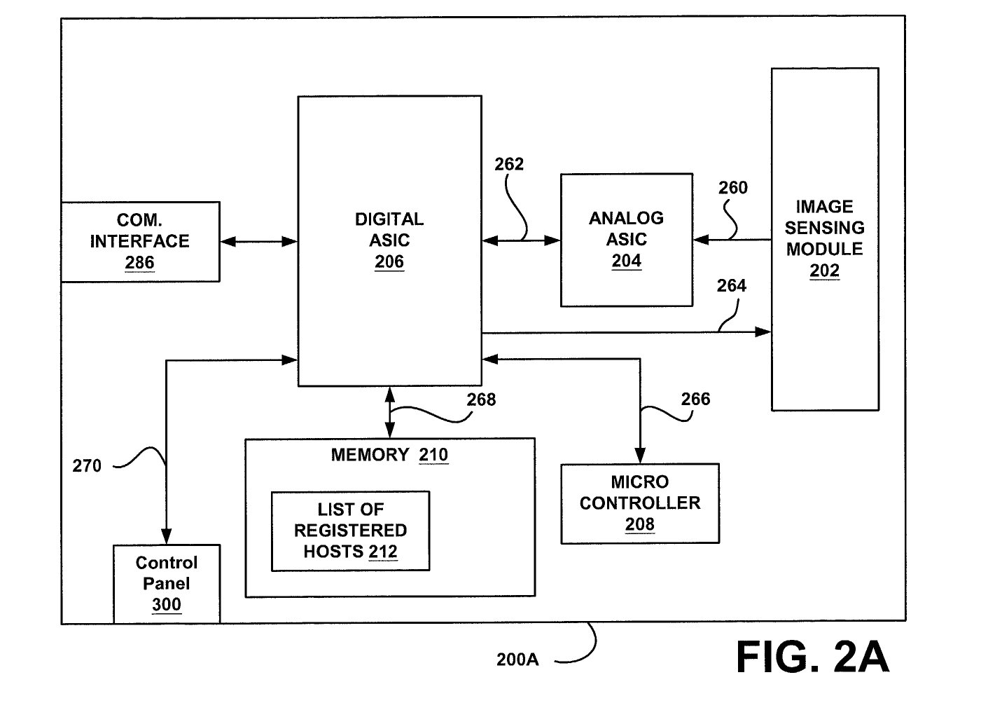

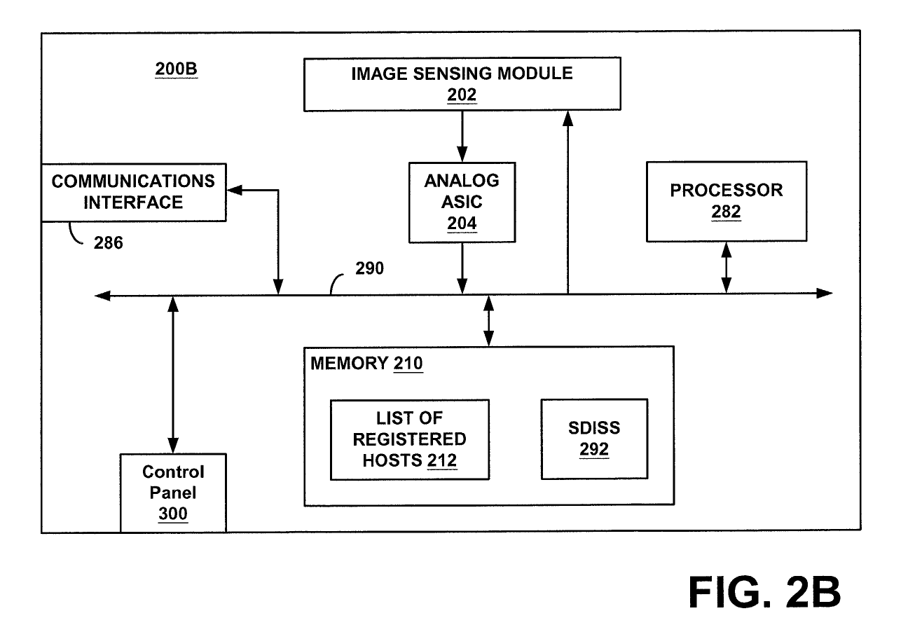

With additional reference to FIGS. 1A, 1B, and 1C throughout the remaining figures. FIG. 2A is a block diagram depicting a non-limiting example of a scanning device 200 in accordance with one embodiment of the present invention. Scanning device 200A includes an analog ASIC 204 adapted to receive analog signals from image sensing module 202 via path 260. The image sensing module may be, for example, a charge-coupled device (CCD), or a contact-image sensor (CIS). Analog ASIC 204 provides amplification, multiplexing, and analog to digital conversion of the analog signals received from image sensing module 202.

A Digital ASIC 206 is used to compress data, to manage memory 210, to communicate with a host 400, and to control the operation of image sensing module 202. Digital ASIC 206 provides coordinated access to memory 210 which may be used to buffer digitized scanned image data and to store a list of registered hosts 212. The list of registered hosts 212 may include host IDs and respective host technical identification numbers. Memory 210 preferably includes Random Access Memory (RAM). In general, however, memory 210 may include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 210 may incorporate electronic, magnetic, optical, and/or other types of storage media. Note that the memory 210 can have a distributed architecture, where various components are situated remote from one another, but can be accessed by the Digital ASIC 206.

Digital ASIC 206 also provides an interface mechanism for microcontroller 208 to manage the overall operation of scanning device 200A. Microcontroller 208 and Digital ASIC 206 transmit control signals and receive status signals to/from input/output (I/O) unit 300 via bus 270. Control panel 300 may include user interface buttons for receiving user input and a display panel for displaying scanning options, instructions, and/or feedback to a user.

One or more communications interfaces 286 (only one is shown) are used to connect the scanning device 200A to one or more host computers. Each communications interface 286 may be, for example, a USB interface, a parallel port interface, a (Small Computer System Interface) SCSI interface, or an IR interface. The preferred host interface connection may depend upon the particular application environment in which scanning device 200A is utilized. In general, however, a USB interface is preferred, where applicable, for its inherent simplicity. In one possible embodiment, scanning device 200A may have three communication interfaces such as, for example, a USB interface, a parallel port interface, and an IR interface.

It will be appreciated by those skilled in the art that the functionality provided by two or more of the components shown in FIG. 2A may instead be provided by only one component; for example, Analog ASIC 204 and Digital ASIC 206 may be replaced with one ASIC (not shown) that performs the functions of both components 204 & 206. Similarly, the functionality provided by a single component may instead be provided by two or more components; for example, Analog ASIC 204 may be replaced with the following components (not shown): an amplifier, a multiplexer, and an analog to digital converter (ADC). It will also be appreciated by those skilled in the art that embodiments of the present invention may be implemented in a wide variety of image scanning devices having a wide variety of internal and external configurations. As a non-limiting example, embodiments of the present invention may be implemented in flatbed scanners, sheet-fed scanners, drum scanners, slide scanners, photo scanners, and multifunction devices (MFDs), etc.

FIG. 2B depicts a non-limiting example of a scanning device 200B that is an alternative embodiment of the scanning device 200A (FIG. 2A). In this example, scanning device includes at least one processor 282, memory 210, input/output (I/O) unit 300, and a communications interface 286, all of which are communicatively coupled via a local interface 290. The local interface 290 can be, for example but not limited to, one or more buses or other connections, as is known in the art.

The processor 282 is a hardware device for executing software, particularly that stored in memory 210. The processor 282 can be any custom made or commercially available processor, a central processing unit (CPU), an auxiliary processor among several processors associated with the scanning device 200, a semiconductor based microprocessor (in the form of a microchip or chip set), a digital signal processor, or generally any device for executing software instructions.

The software in memory 210 may include one or more separate programs, each of which comprises an ordered listing of executable instructions for implementing logical functions. In the example of FIG. 2B, the software in the memory 210 includes a Scanning Device Implemented Scanning Software (SDISS) 292. The SDISS 292 is a source program, executable program (object code), script, or any other entity comprising a set of instructions to be performed. When a source program, then the program needs to be translated via a compiler, assembler, interpreter, or the like, which may or may not be included within the memory 210. Furthermore, the SDISS 292 can be written as (a) an object oriented programming language, which has classes of data and methods, or (b) a procedure programming language, which has routines, subroutines, and/or functions; the programming language may be, for example, but not limited to, C, C++, Pascal, Basic, Fortran, Cobol, Perl, Java, and Ada, etc.

When the scanning device 200 is in operation, the processor 282 is configured to execute software stored within the memory 210, to communicate data to and from the memory 210, and to generally control operations of the scanning device 200 pursuant to the software. The SDISS 292 is read by the processor 282, perhaps buffered within the processor 282, and then executed.

When the SDISS 292 is implemented in software, as is shown in FIG. 2, it should be noted that the SDISS 292 can be stored on any computer readable medium for use by or in connection with any computer related system or method. In an alternative embodiment, where the SDISS 292 is implemented in hardware, the SDISS 292 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

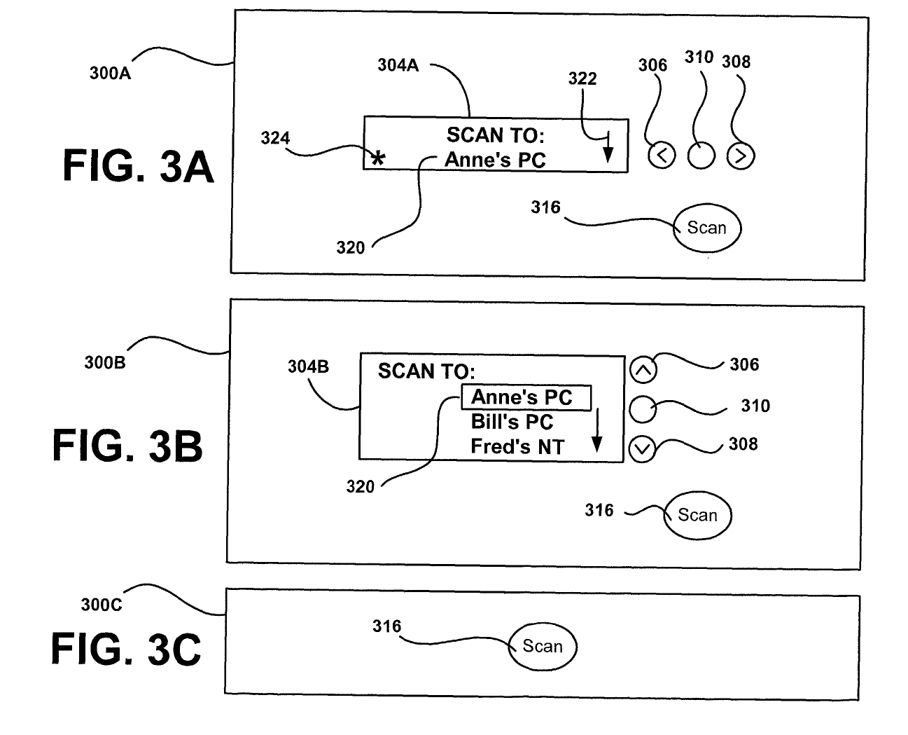

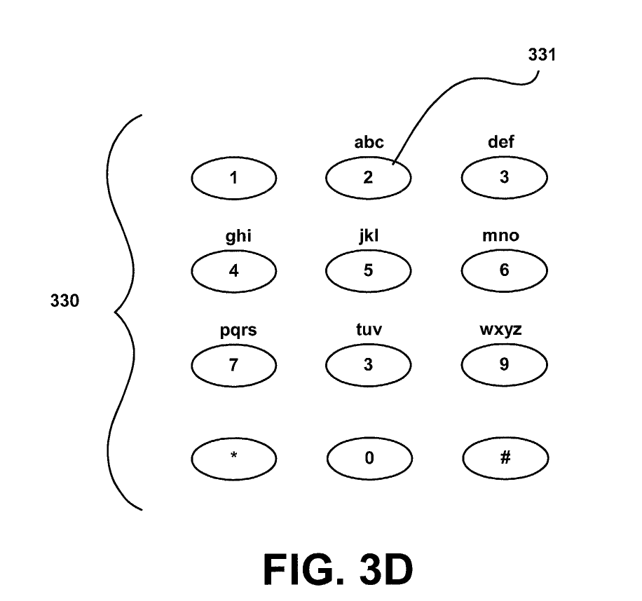

FIG. 3A depicts a non-limiting example of selected components of a control panel 300A that can be used to receive user input designating a destination for scan data. Control panel 300A includes a display panel 304A for displaying host IDs, arrow buttons 306 & 308 for browsing through a list of host IDs, an Enter button 310 for selecting a currently displayed host ID, and a Scan Button 316 for initiating a scan. The display panel 304A may be of any suitable type such as, for example, a liquid crystal display (LCD) or a light emitting diode (LED) display. A host ID is typically a name that is created by a host user and that is used to identify a host 400. The display panel 304A displays a host ID 320, an optional arrow symbol 322, and an optional star symbol 324; the arrow symbol 322 indicates that additional host IDs can be viewed by scrolling up or down the host list using arrow buttons 306 & 308, and the star symbol 324 indicates that the host ID 320 corresponds to a default host. In one possible implementation, the user may press the Scan Button 316 twice in order to scan to the default host without having to expressly identify the default host as the desired destination for the scan data.

FIG. 3B depicts a non-limiting example of a control panel 300B that is an alternative embodiment of the control panel 300A (FIG. 3A). Control panel 300B is different from control panel 300A in that the former includes a larger display panel 304B for displaying multiple host IDs. A user can highlight a desired host ID by using the arrow buttons 306 & 308 and can use the enter button 310 to select a highlighted host ID. In yet another embodiment, a control panel 300 may not include a display panel for displaying a list of registered hosts. A simplified depiction of such an control panel is shown in FIG. 3C.

Control panels 300A, 300B, and 300C (FIGS. 3A, 3B, & 3C) may include additional buttons (not shown) for receiving user input. Such additional buttons may include, for example, where applicable, one or more of the following: a number pad 330 (FIG. 3D) for inputting alpha-numeric characters, a button for inputting a space, a button for requesting a menu, a button for repositioning a cursor, a button for adjusting contrast, and a button for adjusting resolution, among others. Furthermore, the size, shape, number, and location of the input buttons and display panel used in connection with an embodiment of the present invention may be different than illustrated in FIGS. 3A, 3B, & 3C. For example, in an alternative embodiment, a touch-sensitive display panel (not shown) may be used to receive user input, thereby eliminating the need for one or more discrete input buttons.

FIG. 3D depicts a non-limiting example of a number pad 330 that can be integrated into a control panel 300 and that can be used to provide user input. A user can input a number by pressing a button that displays such number. A user can also input a letter by pressing a button that corresponds to such letter. The number of times that a button is pressed to input a letter depends on the position of the letter in the list of letters displayed above the button. For example, button 331 may be pressed once to input the number 2, twice to input the letter A, three times to input the letter B, and four times to input the letter C. In one possible implementation, after a user presses the Scan Button 316, the user can use the number pad 330 to input the first letter of a desired host ID so that the display panel 304 can display one or more host IDs that begin with the inputted letter. This can be especially useful if there is a large number of registered hosts. In another possible implementation, a user may use the number pad 330 to register a host 400 by entering the necessary registration information. The registration information may include a host ID and a host technical ID, as discussed further below.

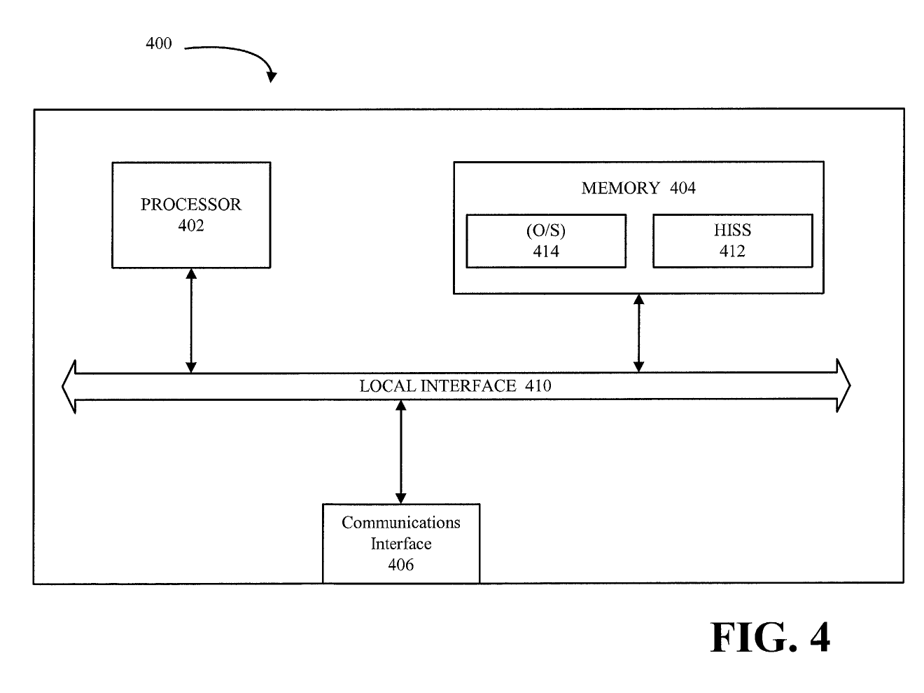

FIG. 4 is a block diagram depicting a non-limiting example of a host 400 that can be used to communicate with a scanning device 200. The host 400 may be a special or general purpose digital computer, such as a personal computer (PC; IBM-compatible, Apple-compatible, or otherwise), a workstation, a minicomputer, or a mainframe computer. Generally, in terms of hardware architecture, as shown in FIG. 4, the host 400 includes a processor 402, memory 404, and a communication interface 406 that are communicatively coupled via a local interface 410.

One or more communication interfaces 406 (only one is shown) may be used to receive user input and/or to provide user output via one or more devices or components that are coupled to respective communication interfaces 406; user input may be provided via, for example, but not limited to, a keyboard, a mouse, a microphone, a scanning device 200, and/or a touch-screen display; user output may be provided via, for example, but not limited to, a monitor, a speaker, and/or a printer.

When the host 400 is in operation, the processor 402 is configured to execute software stored within the memory 404, to communicate data to and from the memory 404, and to generally control operations of the host 400 pursuant to the software. The host implemented scanning software (HISS) 412 and the operating system (O/S) 414 are read by the processor 402, perhaps buffered within the processor 402, and then executed.

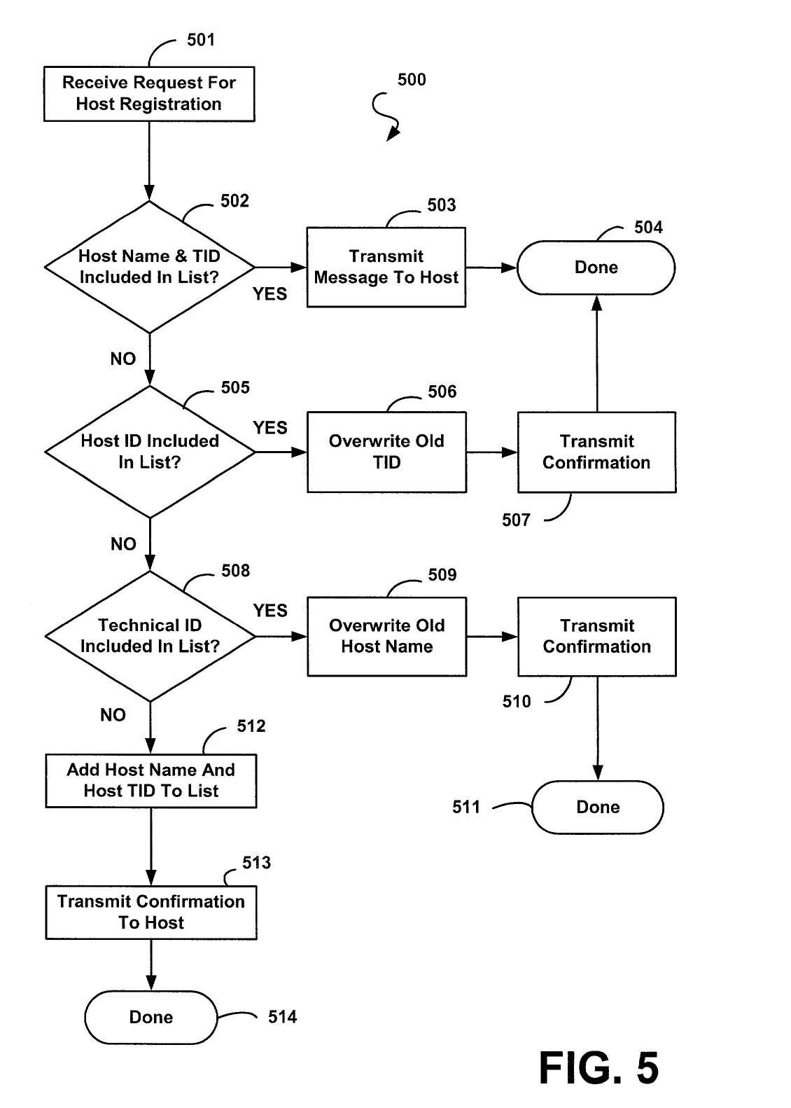

In an embodiment of the present invention, a registration request may be transmitted just after or during HISS 412 installation from a host 400 to a scanning device 200 with which the host 400 has a direct connection, preferably without requiring user input that specifically directs the host 400 to register with the scanning device 200. However, if a host 400 is connected to a scanning device 200 via a network 104 (FIG. 1B), the host 400 will preferably not transmit a registration request just after or during HISS 412 installation unless the host 400 is prompted to do so by a user. In one implementation, the first time that the user activates the HISS 412 after it is installed, a message will be displayed to the user instructing the user on how the host 400 can be registered with the scanning device 200. A user may be required to enter a host ID before the host 400 can transmit a registration request to the scanning device 200. Alternatively, the host 400 may use a predetermined name such as, for example, a network log-in name, as the host ID. When the scanning device 200 receives a registration request from the host 400, then the scanning device 200 may implement a host registration routine such as, for example, as illustrated in FIGS. 5 & 6.

During host shut-down or if a user logs-off a host 400, if the host 400 is registered with a scanning device 200 for a scan, the HISS 412 will cancel registration with the scanning device 200, and will store in memory the user's profile. The user's profile includes a user entered host ID and data indicating whether the user is to be registered for a scan the next time that the user logs-in or the host 400 is powered up. In this manner, when the user logs-in to the host 400, or when the host 400 is powered-up, the host 400 may register for a scan using the last entered host ID, and the user's host environment can be restored without requiring additional user input.

The HISS 412 may contain functionality enabling a user to change the host ID and to cancel registration or re-register for scanning with the scanning device 200. This functionality may be implemented via one or more menus that include one or more scanning device registration options. Scanning device registration options may be displayed on a display device (not shown) that is coupled to the host 400, and may include, for example, the following respective phrases: “Register With Scanner,” “Cancel Registration With Scanner,” and “Change host Name.” Of-course, the exact language used to identify these options may be different than indicated above.

III. System Operation and Functionality

FIG. 5 depicts a non-limiting example of a host registration routine (HRR) 500 that is implemented by a scanning device 200 that includes a display panel 304. The HRR 500 is initiated in step 501 when the scanning device 200 receives a registration request from a host 400. The registration request may include a host ID and a host technical ID (TID).

After the routine 500 is initiated in step 501, the routine 500 determines in step 502 if the host ID and host TID are already included in the list of registered hosts 212 (FIGS. 2A and 2B). If the host ID and host TID are already included in the list of registered hosts 212, then the routine 500 initiates in step 503 the transmission of a message to the host 400 informing it that it is already registered, and the routine 500 then terminates in step 504.

If the routine 500 determines that the host ID and host TID are not already included in the list of registered hosts 212, then the routine 500 determines in step 505 if the host ID is already included in the list of registered hosts 212. If the host ID is already included in the list 212, then the routine 500, in step 506, causes the previously stored TID corresponding to the host ID to be over-written with the current TID, initiates in step 507 the transmission of a confirmation message to the host 400 informing it that it has been registered, and then terminates in step 504.

If the routine 500 determines in step 505 that the host ID is not already included in the list of registered hosts 212, then the routine 500 determines in step 508 if the host TID is already included in the list of registered hosts 212. If the routine 500 determines that the host TID is already included in the list 212, then the routine 500, in step 509, causes the previously stored host ID corresponding to the current host TID to be over-written with the current host ID, initiates in step 510 the transmission of a confirmation message to the host 400 informing it that it has been registered, and then terminates in step 511.

If the routine 500 determines in step 508 that the host TID is not already included in the list of registered hosts 212, then the routine 500 causes, in step 512, the host ID and host TID to be included in the list of registered hosts 212, initiates in step 513 the transmission of a message to the host 400 informing it that it has been registered, and then terminates in step 514.

In an alternative embodiment of the present invention, a host registration routine may be implemented with fewer, additional, different, or differently ordered steps than those in HRR 500. For example, in one embodiment, a host registration routine may not include steps 502-504, steps 505-507, and/or steps 508-511; in another embodiment, step 508 may be implemented prior to step 505.

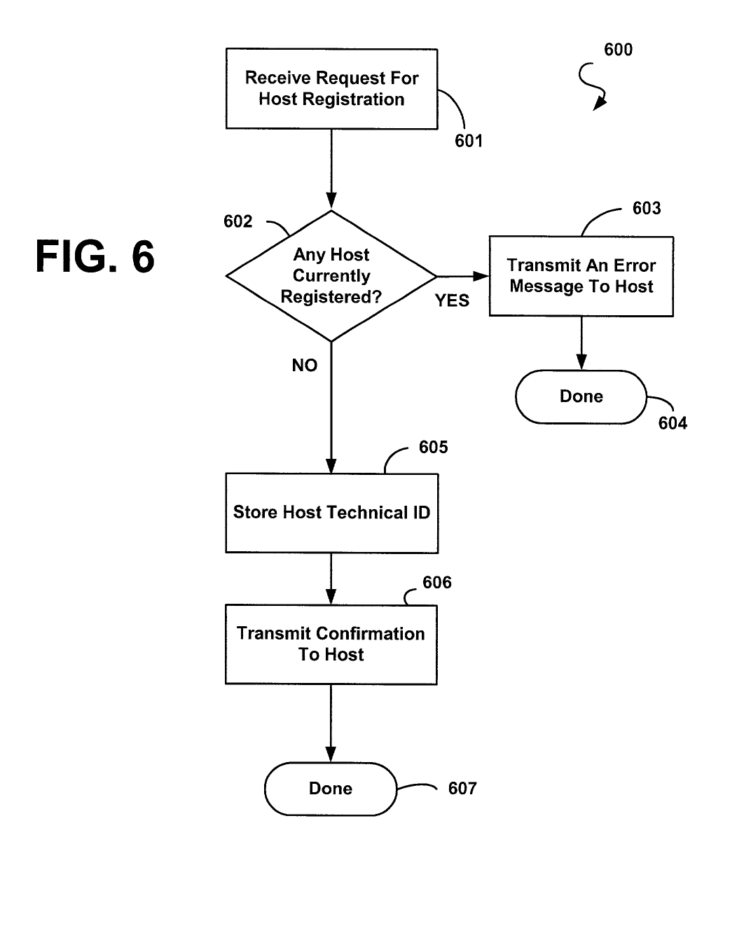

FIG. 6 depicts a non-limiting example of a host registration routine 600 that is implemented by a scanning device 200 that does not include a display panel 304. The routine 600 is initiated in step 601 when the scanning device 200 receives a registration request from a host 400. The registration request may contain a host TID. The routine then determines in step 602 if any host is currently registered; if any host is currently registered, then the routine initiates, in step 603, the transmission of an error message to the host 400 and then terminates in step 604. However, if no host is currently registered, then the routine causes the requesting host's TID to be stored in memory 210, initiates the transmission of a confirmation message to the host 400, and then terminates, as indicated in steps 605, 606, and 607, respectively.

In one embodiment, HRR 500 (FIG. 5) and HRR 600 (FIG. 6) are part of SDISS 292 (FIG. 2B). Steps shown in HRR 500 and HRR 600 may represent modules, segments, or portions of code which include one or more executable instructions for implementing specific logical functions or steps in a process. Alternate implementations are included within the scope of the preferred embodiment of the present invention in which functions or steps may be executed out of order from that shown or discussed, including substantially concurrently or in reverse order, depending on the functionality involved, as would be understood by those reasonably skilled in the art.

It will be appreciated by those skilled in the art that the functionality provided by HRR 500 and HRR 600 can also be implemented through hardware such as, for example, Digital ASIC 206 (FIG. 2A) and supporting circuitry. Each implementation has its advantages, however. For example, hardware enjoys a speed and, arguably, a reliability advantage over software because hardware testing and verification methods are currently more advanced than software verification methods. On the other hand, software can be less expensive than customized hardware and offers greater flexibility in adding or modifying product features. It will be also be appreciated by those skilled in the art that the functionality provided by each of the routines illustrated in FIGS. 5 and 6 may be implemented in a combination of software and hardware such as, for example, software stored in memory 210 (FIG. 2A) and logic implemented via Digital ASIC 206 (FIG. 2A).

Further, the functionality provided by each of the routines illustrated in FIGS. 5 and 6, can be embodied in any computer-readable medium for use by or in connection with a computer-related system (e.g., an embedded system such as a modem) or method. In this context of this document, a computer-readable medium is an electronic, magnetic, optical, semiconductor, or other physical device or means that can contain or store a computer program or data for use by or in connection with a computer-related system or method. Also, the computer program or data may be transferred to another computer-readable medium by any suitable process such as by scanning the computer-readable medium. Thus, the computer-readable medium could be paper or other suitable medium upon which the computer program can be printed, scanned with an optical scanning device, and transferred into the computer's memory or storage.

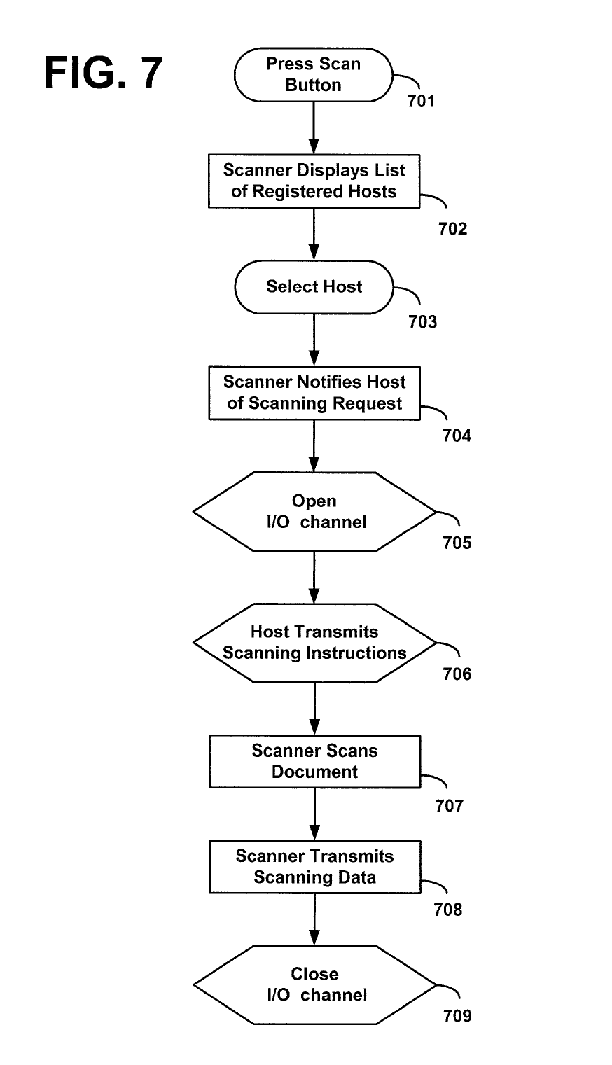

FIG. 7 is a flow chart depicting one embodiment of a scanning process 700 for a scanning device 200 that has a display panel 304. In general, steps 701 and 703 are performed by a user; steps 702, 704, 707, and 708 are performed by the scanning device 200; and steps 705, 706, and 709 are performed by the host 400. In one possible embodiment, however, steps 705 and 709 may be performed by the scanning device 200.

After a user presses a Scan Button 316 (FIG. 3A or 3B) as indicated in step 701, the scanning device 200 displays a list of host IDs as indicated in step 702. The list may be scrollable in response to user input, and may be displayed via a display panel such as, for example, display panel 304A (FIG. 3A) that displays one host ID at a time, or display panel 304B (FIG. 3B) that displays a plurality of host IDs simultaneously. In a preferred embodiment, the host IDs are listed in alphabetical order; as the user scrolls down the list, the host ID that is next in alphabetical order is displayed. If the scanning device 200 has an IR interface and establishes a connection with a host 400 via the IR interface, then the host ID corresponding to such host 400 will be at the top of the list of registered hosts. In this manner, the scanning device 200 can provide a convenient walk-up model for hosts with IR interfaces.

In step 703, a user selects a host ID from the list of host IDs. User input may be provided, for example, via one or more control buttons such as for example, buttons 306, 308, & 310 (FIGS. 3A & 3B). In one possible implementation, if the user want to “jump” to a specific host ID, the user can enter one or more characters of the desired host ID. A character may be entered via, for example, a number pad 330 (FIG. 3D) that is integrated into a control panel 300 (FIGS. 2A & 2B).

In step 704, the scanning device 200 notifies the selected host of the pending scanning request. The scanning device 200 may use a TID stored in scanning device memory and corresponding to the selected host to communicate with the selected host. In one possible implementation, a user may be required to enter a valid personal identification number (PIN) before the scanning device 200 can proceed with implementing the user's scanning request.

After the scanning device 200 notifies the host 400 of the scanning request, the host 400 opens an I/O communication channel with the scanning device 200 and then transmits scanning instructions to the scanning device 200, as indicated in steps 705 and 706 respectively. Scanning instructions may include, for example, the desired image resolution and the number of bits per pixel (bpp), etc. In an alternative embodiment, step 705 comprises the scanning device 200 opening the I/O communication channel with the host 400. In yet another alternative embodiment, a user may be able to enter or modify scanning settings using the control panel 300 (FIG. 3).

The scanning device 200 then scans, in accordance with the host scanning instructions, one or more documents or images provided by the user and transmits the resulting scan data to the host 400, as indicated in steps 707 and 708, respectively. In one embodiment, a scanning device's display panel 304 informs the user that the images being scanned will be transmitted to the selected host; the display panel 304 may state, for example, “Scanning to;” followed by the selected host ID. After the host 400 receives the scan data, the host 400 closes the I/O communication channel, as indicated in step 709. In an alternative embodiment, step 709 comprises the scanning device 200 closing the I/O communication channel with the host 400.

In an alternative embodiment of the present invention, a scanning process may be implemented with fewer, additional, different, or differently ordered steps than those in scanning process 700. For example, alternative embodiments may comprise the following steps that are performed in the following order: step 701, step 707, step 703, and then step 708; another alternative embodiment may comprise the following steps: step 703, step 701, step 707, and then step 708; yet another alternative embodiment may not require a user to press a scan button and may comprise steps that are performed in the following order: step 702, step 703, step 707, and then step 708.

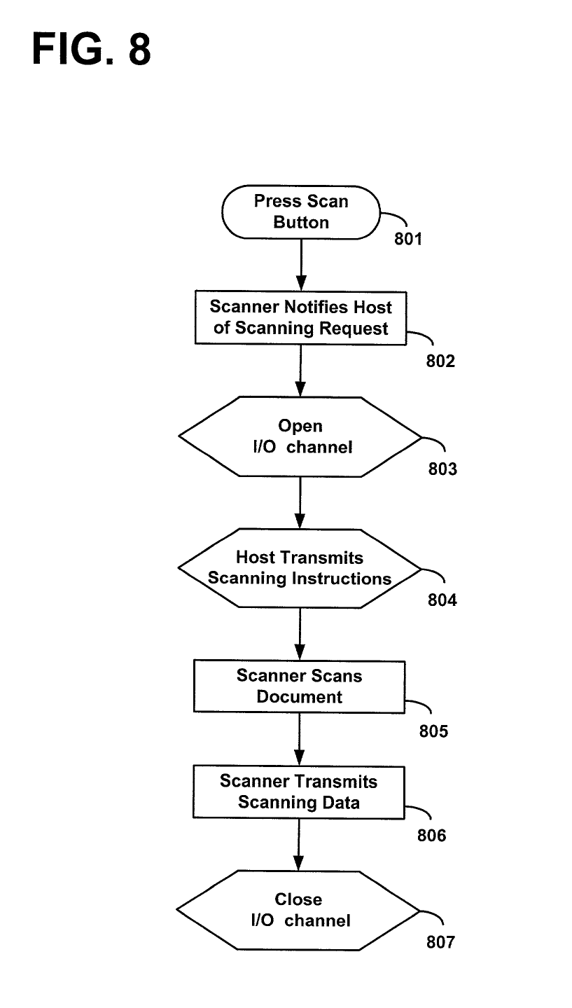

FIG. 8 is a flow chart depicting a non-limiting example of a scanning process 800 for a scanning device 200 that allows only one host to be registered, at any given time, to receive a scan. Such a scanning device may be, for example, a scanning device 200 that does not have a display panel 304 capable of displaying a list of registered hosts. After a user presses a Scan Button 316 (FIG. 3C) as indicated in step 801, the scanning device 200, in step 802, notifies the registered host of the pending scanning request. After the scanning device 200 notifies the registered host of the scanning request, the registered host opens an I/O communication channel with the scanning device 200 and then transmits scanning instructions to the scanning device 200, as indicated in steps 803 and 804 respectively. In an alternative embodiment, step 803 comprises the scanning device 200 opening the I/O communication channel with the host 400.

The scanning device 200 then scans, in accordance with the registered host scanning instructions, one or more documents or images provided by the user and transmits the resulting scan data to the registered host, as indicated in steps 805 and 806, respectively. After the registered host receives the scan data, the registered host closes the I/O communication channel, as indicated in step 807. In an alternative embodiment, step 807 comprises the scanning device 200 closing the I/O communication channel with the host 400.

It should also be emphasized that the above-described embodiments of the present invention, particularly any “preferred embodiments”, are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and present invention and protected by the following claims.

What is claimed is:

1. A scanning method comprising:
displaying a host identifier (ID) for identifying a host computer;
receiving user input selecting the host ID;
scanning a document or image to generate scan data; and
transmitting the scan data to the host computer.

2. The method of claim 1, where the host ID is displayed in response to receiving user input requesting a scan.

3. The method of claim 1, further comprising:
displaying a plurality of host identifiers.

4. The method of claim 1, further comprising:
prior to displaying the host ID, receiving registration data containing the host ID from the host computer; and
prior to scanning the image or document, transmitting a scanning request to the host computer and receiving a scanning instruction from the host computer.

5. The method of claim 1, where the host computer is a personal computer (PC).

6. The method of claim 1, where the method is implemented via a scanning device.

7. The method of claim 6, where the scanning device is coupled to the host computer via a network.

8. The method of claim 6, where the scanning device is coupled to the host computer via a direct connection.

9. A scanning device for scanning to a host computer comprising:
memory for storing a host identifier (ID);
an image sensing module for scanning an image or document, where the scanning is used to generate scan data; and
a display panel for displaying the host ID, where the scanning device transmits the scan data to the host computer that is identified by the host ID in response to receiving user input selecting the displayed host ID.

10. The scanning device of claim 9, further comprising:
means for transmitting a scanning request to the host computer; and
means for receiving a scanning instruction from the host computer.

11. The scanning device of claim 9, where the host computer is a personal computer (PC).

12. The scanning device of claim 9, where the scanning device is coupled to the host computer via a network.

13. The scanning device of claim 9, where the scanning device is coupled to the host computer via a direct connection.

14. The scanning device of claim 9, where the image sensing module comprises a charge-coupled device (CCD) or a contact-image sensor (CIS).

15. The scanning device of claim 9, where the scanning device is a flat-bed scanner, a sheet-fed scanner, or a multifunction device.

16. A method for scanning comprising:
transmitting a registration request to a scanning device;
receiving a scanning request from the scanning device;
transmitting a scanning instruction to the scanning device in response to receiving the scanning request;
receiving scan data from the scanning device; and
transmitting a request to the scanning device requesting a cancellation of registration.

17. The method of claim 16, where the method is implemented via a host computer.

18. The method of claim 17, where the registration request includes a host identifier (ID) for identifying the host computer.

19. The method of claim 17, where the request for registration is transmitted in response to user input requesting registration with the scanning device, in response to the host computer powering up, in response to a user logging on to the host computer, or in response to a user logging on to a network to which the host computer is coupled.

20. The method of claim 17, where the request for cancellation of registration is transmitted in response to user input requesting cancellation of registration, in response to the host computer powering down, in response to a user logging off from the host computer, or in response to a user logging off from a network to which the host computer is coupled.
